(19) United States
(12) Patent Application Publication
(10) Pub. No.: US 2003/0162437 A1
(43) Pub. Date: Aug. 28, 2003

(54) Tray for routing electronic instrument cables

(76) Inventors: Dennis Erenberger, Colorado Springs, CO (US); Michael Dancel, Colorado Springs, CO (US); Omar Guadalupe Pena, Colorado Springs, CO (US)

Correspondence Address: AGILENT TECHNOLOGIES,INC., Legal Department, DL 429, Intellectual Property Administration, P.O. Box 7599, Loveland, CO, 80537-0599, US

(21) Appl. No.: 10/083,175

(22) Filed: Feb. 26, 2002

(51) Int. Cl. H01R 11/00

(52) U.S. Cl. 439/502

(57) ABSTRACT

A cable management solution allows cables connected on a first face of an electronic instrument to be routed to a different second face of the instrument. A cable routing tray, preferably mounted to the instrument, includes one or more channels each having an ingress located in proximity to the first face of the instrument and an egress located in proximity to the second face of the instrument. Each cable channel includes support means to support and route a cable through the channel. To route a ribbon cable connected to the instrument connector on the first face of the instrument, the cable is squeezed, inserted into the channel behind the support means and such that it enters the channel at the channel ingress and exits the channel at the channel egress. The cable routing tray allows a user of the instrument the option of extending the cable out either the first face or the second face of the electronic instrument and assists in cable organization.

### FIELD OF THE INVENTION

The present invention pertains generally to electronic instruments, and more particularly to a cable routing tray attachable to an electronic instrument for allowing a user to route cables connected on one face of the instrument to extend out another face of the instrument.

### BACKGROUND OF THE INVENTION

In electronic and computer test environments, a device under test is often connected to electronic instruments for obtaining state, timing, and/or electrical parameter information. The tools in such environment may include, for example, emulators, logic analyzers, oscilloscopes, and computers, to name a few. The device under test is typically attached to a target system board. The target system board has probe pins electrically connectable to pins/nodes of the device under test. The probe pins are connected to probe connectors on the target system board, which are connectable to probes on probe cables compatible with the various instruments of interest.

In order to sufficiently capture enough information to properly test and/or debug the device under test, numerous cables are often required. For example, in a microprocessor-based device under test, the signals of interest will typically include data and address busses, and any number of other signals. In advanced multiple bus architectures with bus sizes often of 128- or 256-signals wide, such a test setup can amount to an unwieldy amount of cables associated with capturing the data from the target system.

In addition to the probe cables on the test instruments, each test instrument may have numerous other cables associated with it. For example, a test instrument typically includes a power cable, keyboard and mouse cables, and other I/O cables such as a network connection cable). Consequently, managing the aggregation of cables associated with the test setup can be cumbersome.

Test instruments commonly provide cable connections for a given cable on only one face of the instrument. However, depending on the application, it would often be beneficial to have the cables extend out a different face of the instrument than the face that the cable connector is provided.

In addition, unless managed properly, the cables can become a tangled mass. Furthermore, a large number of cables proximate to the air intake of air exhaust openings of the electronic instrument can block airflow, and potentially cause the electronic instrument to overheat.

Accordingly, it would be beneficial to have a test instrument which allows the user the option of accessing the cables from at least two different faces of the instrument. It would also be beneficial to have a device that offers a cable management solution to prevent cables from becoming entangled and to assist in keeping the airflow openings of the instrument housing clear for proper airflow.

### SUMMARY OF THE INVENTION

The present invention is a cable management solution which allows cables connected on the face of an electronic instrument to be routed to a different face of the instrument. In particular, the preferred embodiment of the invention is a cable routing tray mountable to the electronic instrument. The tray allows a user the option of routing cables connected at the rear of the instrument to the front of the instrument. Thus, the user has the option of attaching the logic analyzer probes to circuitry located either in back or in front of the instrument.

In a preferred embodiment, the cable routing tray is a molded plastic tray having a plurality of channels, each having a channel entrance located in proximity to the cable connector on the rear of the instrument and a channel exit along the front of the instrument. Each cable channel is formed with a width and depth sufficient to accommodate at least one cable therein. Each cable channel also includes support means that operate both to support and route a cable through the channel, and also to hold the cable inside the cable channel. In the preferred embodiment, the support means comprise a plurality of tabs that extend co-planar with and into the channel aperture. To route a ribbon cable connected to the instrument connector on the rear panel of the instrument, the cable is squeezed, inserted into the channel behind the tabs, and pulled tight to take up any slack in the cable.

The cable routing tray of the invention is advantageous in several ways. To this end, the cable routing tray allows a user of the instrument the option of using a rear cable configuration or a front cable configuration without requiring redundant cable connectors on the front of the instrument. This eliminates redesign of the front panel of the instrument, and costs less in terms of parts and circuitry. In addition, the cable routing tray routes the cables along organized channels to provide organization and simplified access of the different cables.

The cable routing tray of the invention allows the user to route one or more cables in either direction, or, where multiple cables are routed through the same channel, both directions at the same time. This allows greater convenience for routing the probe cables in the most efficient manner for the particular test setup. In addition, the cable routing solution of the invention keeps paired cables together, aids in preventing the cables from tangling, provides storage for unused cables and/or for taking up the slack in cables between the cable connection at the target system and the electronic instrument. In instruments with multiple cables routed together as a group, the tray also serves to keep the grouped cables together.

### BRIEF DESCRIPTION OF THE DRAWING

The invention will be better understood from a reading of the following detailed description taken in conjunction with the drawing in which like reference designators are used to designate like elements, and in which:

FIG. 1 is a perspective view of a prior art electronic test environment;

FIG. 2 is a perspective view of an electronic test environment in accordance with the invention;

FIG. 3A is a front perspective view of an example logic analyzer implementing the principles of the invention;

FIG. 3B is a rear perspective view of the example logic analyzer of FIG. 3A;

FIG. 4A is a front perspective view of a cable routing tray implemented in accordance with the invention;

FIG. 4B is a side perspective view of the cable routing tray of FIG. 4A;

FIG. 4C is a rear perspective view of the cable routing tray of FIGS. 4A-4B;

FIG. 4D is a front plan view of the cable routing tray of FIGS. 4A-4C;

FIG. 4E is a rear plan view of the cable routing tray of FIGS. 4A-4D;

FIG. 4F is a plan view of the exposed face of the cable routing tray of FIGS. 4A-4E;

FIG. 4G is a plan view of the mountable face of the cable routing tray of FIGS. 4A-4H;

FIG. 5A is a bottom plan view of the logic analyzer of FIGS. 3A-3B with the cable mounting tray of FIGS. 4A-4G mounted thereon on the bottom panel and cables extending out the rear of the logic analyzer;

FIG. 5B is a rear perspective view of the logic analyzer of FIGS. 3A-3B in the configuration of FIG. 5A;

FIG. 5C is a bottom plan view of the logic analyzer of FIGS. 3A-3B with the cable mounting tray of FIGS. 4A-4G mounted thereon on the bottom panel and cables routed to the front of the logic analyzer in accordance with the principles of the invention;

FIG. 5D is a rear perspective view of the logic analyzer of FIGS. 3A-3B in the configuration of FIG. 5C;

FIG. 5E is a front perspective view of the logic analyzer of FIGS. 3A-3B in the configuration of FIGS. 5C-5D;

FIG. 6A is a front perspective view of an alternative embodiment of a cable routing tray implemented in accordance with the invention;

FIG. 6B is a front plan view of the cable routing tray of FIG. 6A;

FIG. 6C is a rear plan view of the cable routing tray of FIGS. 6A-6B;

FIG. 6D is a side perspective view of the cable routing tray of FIGS. 6A-6C;

FIG. 6E is a plan view of the exposed face of the cable routing tray of FIGS. 6A-6D;

FIG. 6F is a bottom plan view of the cable mounting tray of FIGS. 6A-6E mounted on the bottom panel of the logic analyzer of FIGS. 3A-3B with cables routed through the channels in accordance with the invention.

### DETAILED DESCRIPTION

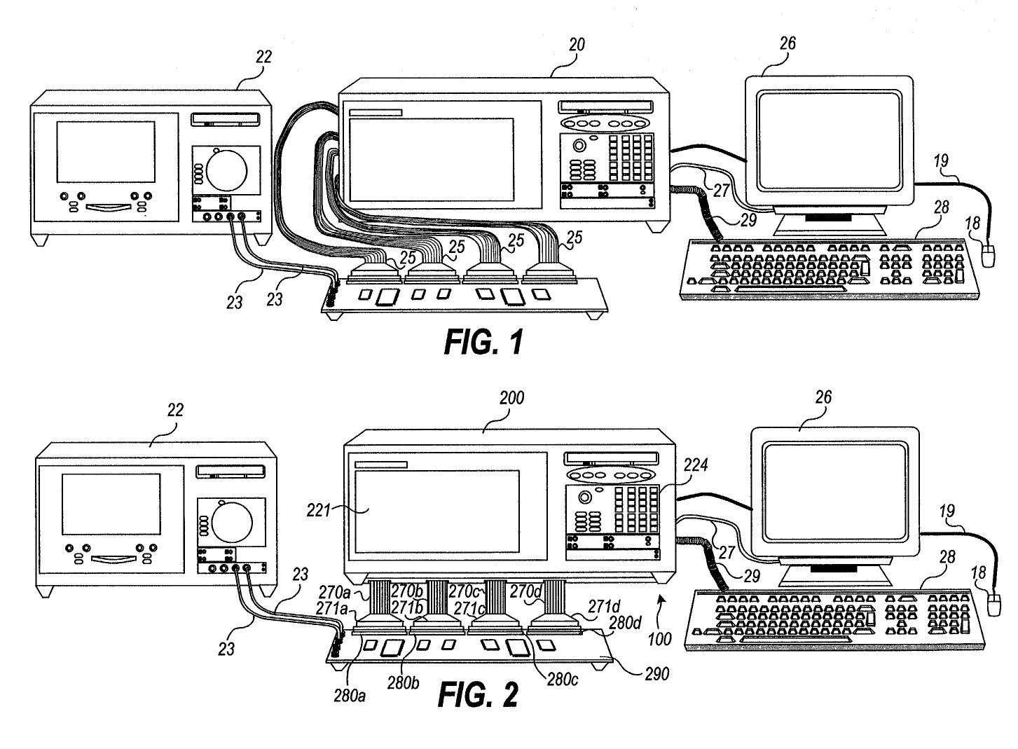

Turning now to FIG. 1, there is shown a perspective view of a prior art test benchmark environment comprising a test instrument 20, such as a logic analyzer, a target test assembly 30, and a plurality of cables 25 connected therebetween. The test instrument 20 may be connected to peripherals such as a computer monitor 26 and keyboard 28 via cables 27 and 29 respectively. Test benchmark environment may also include additional test instruments, for example oscilloscope 22, as shown, with cables 23 connected to the target test assembly 30. Cables 25 attach to cable connectors at the rear of the test instrument 20. As also shown, the target test assembly 30 is positioned in front of the test instrument 20 in order to have convenient access to the target test assembly 30. Accordingly, the cables 25 are pulled around the side of the test instrument 20 to attach to the target test assembly 30 located in front of the test instrument 20. No cable management is in place to assist in preventing tangling of the cables 25.

FIG. 2 is a perspective view of a test setup assembly in accordance with the invention. As shown, this assembly includes a target test assembly 30 located in front of an electronic instrument 200. In the illustrative embodiment, electronic instrument 200 is a logic analyzer 201. Electronic instrument 200 is connected to the test assembly 30 via cables 270a, 270b, 270c, and 270d. As shown in this setup, cables 270a, 270b, 270c and 270d are routed beneath the instrument 200 via a cable routing tray 100 implementing the principles of the invention. The cable routing tray operates to route cables from one part of instrument to another part—in this case from the back of the instrument to the front of the instrument—to allow the user to have the option of extending the cables out the front or out the rear of the instrument 200. As illustrated, when the target test assembly 30 is located in front of the logic analyzer 200, having the pod cables 270a, 270b, 270c, and 270d routed out the front of the instrument via the cable routing tray 100 facilitates a more organized benchmark environment. Furthermore, although it will be appreciated that the cable routing tray 100 may be mounted on any face of the test instrument 200, positioning the tray 100 on the bottom panel of the test instrument 200 prevents the cables 270a-270d from obstructing the view of the display 201 and/or the control panel 224.

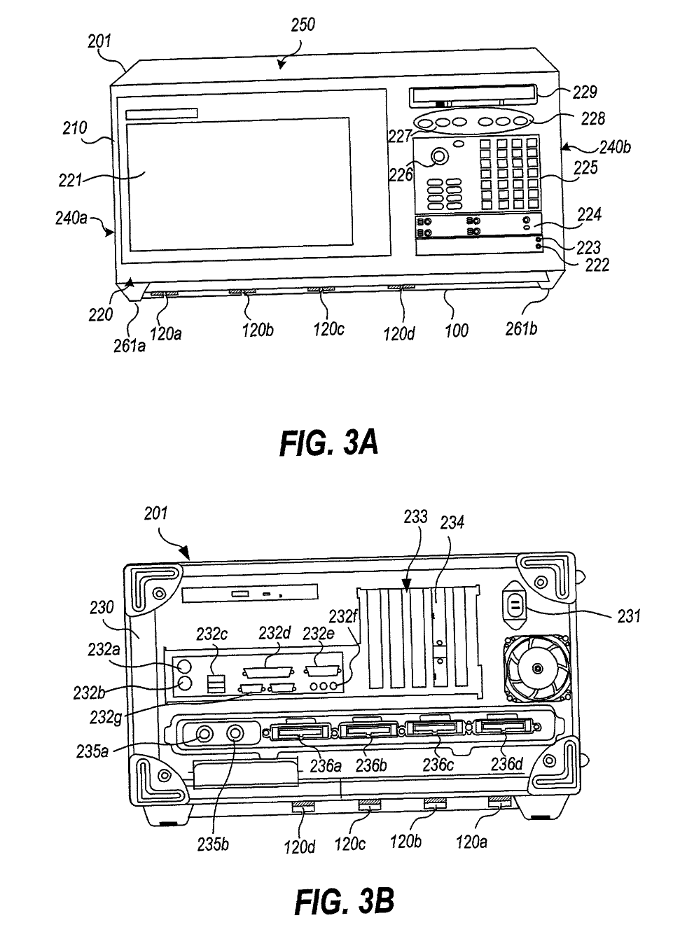

FIG. 3A shows the front panel of an example logic analyzer 201 implementing test instrument 200 the illustrative embodiment of the invention. As illustrated, logic analyzer 201 comprises an instrument housing 210, including a front panel 220, a rear panel 230, side panels 240a and 240b, a top panel 250, and a bottom panel 260. Front panel generally includes display screen 221, a ground input port 222, a clock input port 223, display setting knobs 224 for setting up the format of data output on the display screen 221, an input keypad 225, a scroll knob 226 for scrolling through results displayed on the display screen 221, test execution keys 227 for running and stopping tests, file keys 228 for opening and saving files on disk, and a floppy disk drive 229.

FIG. 3B shows the rear panel 230 of the example logic analyzer 201. As shown, the rear panel 230 of the logic analyzer 201 includes a power connector 231, a peripheral ports panel 232 including a mouse connector 232a, a keyboard connector 232b, USB ports 232c, a parallel port 232d, a serial port 232e, audio ports 232f, and IEEE 1394 ports 232g. Rear panel 230 also includes peripheral expansion slots 233, with a 10/100Base LAN interface card 234 installed. Trigger In and Trigger Out BNC ports 235a and 235b are also provided to allow for external triggering.

The rear panel 230 of the logic analyzer 201 also includes a plurality of pods 236a, 236b, 236c, 236d through which state data from the test assembly may be monitored and input to the logic analyzer 201.

In accordance with the invention, a cable routing tray 100 is attached to one face of the test instrument 200. In the illustrative embodiment, the cable routing tray 100 is physically attached to the bottom panel 260 of the logic analyzer 201, for example using screws, or snap in plugs that fit into hollows formed in the bottom panel 230.

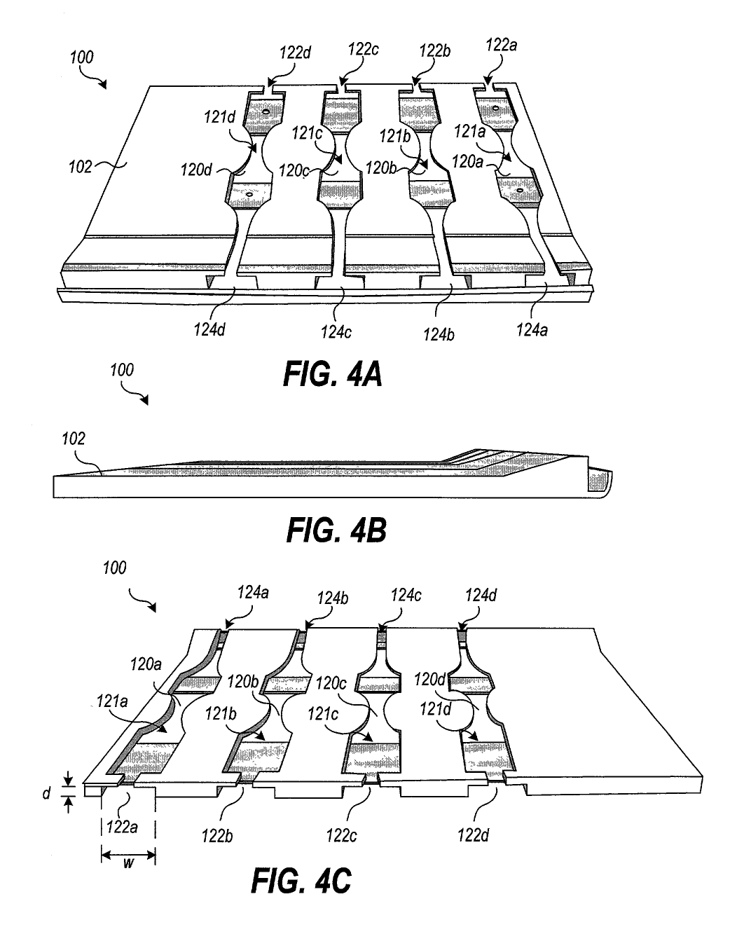

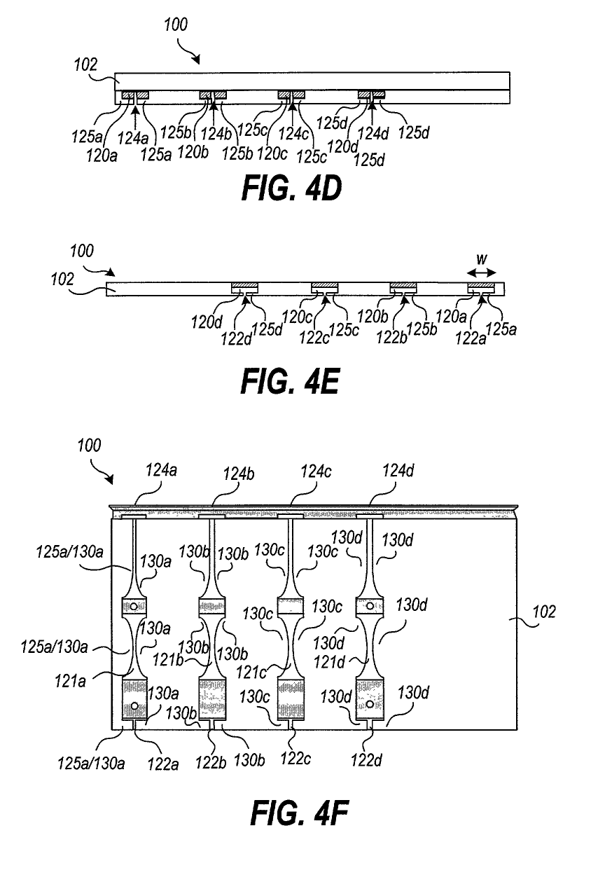

FIGS. 4A-4G illustrate various views of a preferred embodiment of the cable routing tray 100 of the invention for the example application. As illustrated, cable routing tray 100 comprises a substantially flat body 102, preferably made of molded plastic, having a plurality of channels 120a-120d therein. The channels 120a-120d are formed by hollow cavities or grooves each having an aperture 121a-121d on the external face of the body 102. The hollow cavities are formed with a channel width w and channel depth d sufficient to accommodate at least one pod cable 270a-270d therein. Each channel 120a, 120b, 120c, 120d includes an ingress 122a, 122b, 122c, 122d through which a cable enters and an egress 124a, 124b, 124c, 124d through which the cable exits the channel 120a, 120b, 120c, 120d. Each channel 120a, 120b, 120c, 120d also preferably includes support means 125a, 125b, 125c, 125d for ensuring that a cable routed therethrough remains inside the channel. In the preferred embodiment, the support means 125a, 125b, 125c, 125d comprises tabs 130a, 130b, 130c, 130d that protrude co-planar with and into channel aperture 121a, 121b, 121c, 121d. The support tabs 130a, 130b, 130c, 130d are useful especially in the case where the cable routing tray 100 is mounted to the bottom of the electronic instrument 200 since they therefore prevent a cable routed through the channel from unintentionally falling out of the channel.

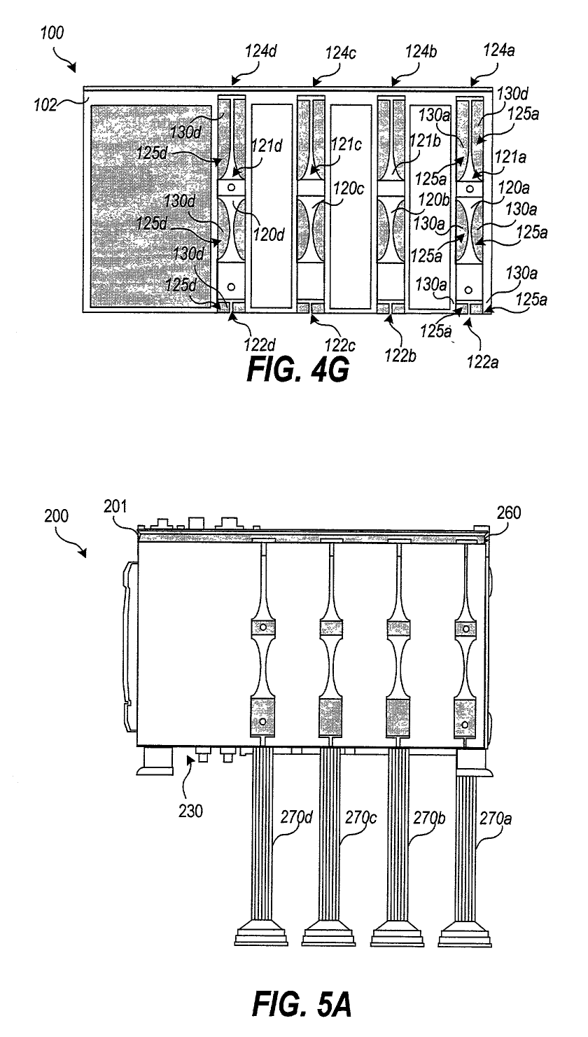

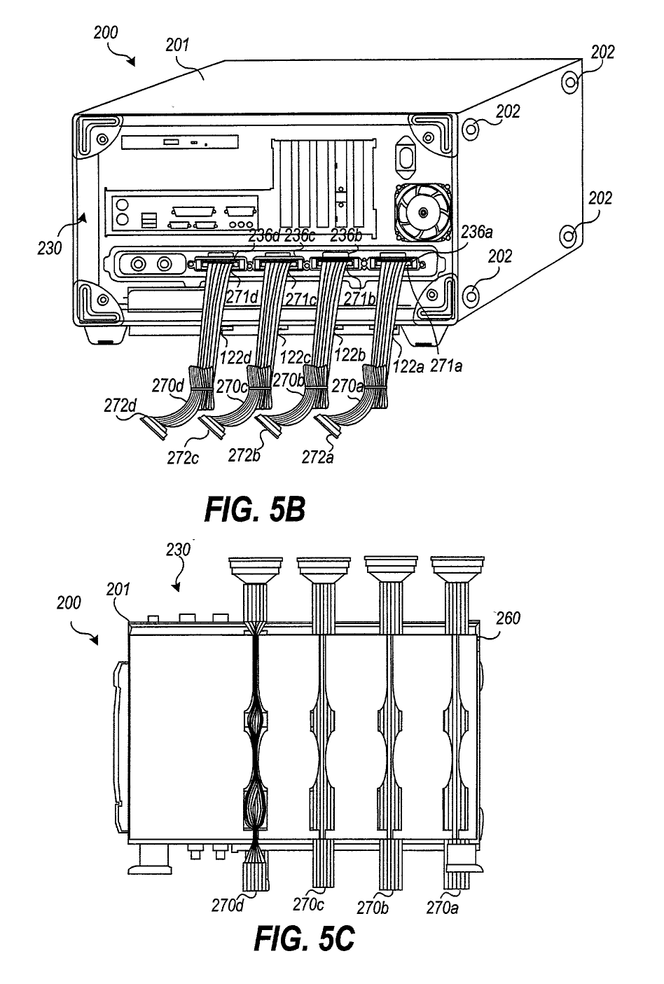

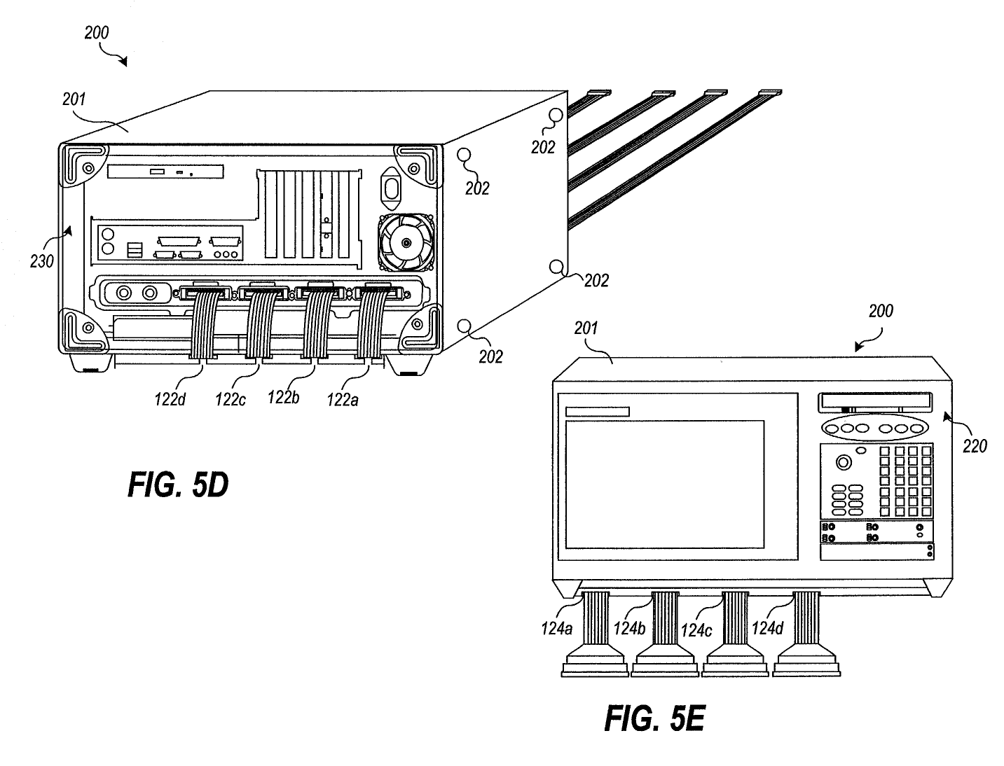

FIGS. 5A-5D illustrate the operation of the tray of the invention. As shown, the cable routing tray 100 is mounted onto the bottom panel 260 of the logic analyzer 201, as shown in FIG. 5A, such that the channel ingresses 122a-122d are located in proximity to the rear panel 230 of the logic analyzer 201 and the channel egresses 124a-124d are located in proximity to the front panel 220 of the logic analyzer 201.

As illustrated in FIG. 5B, a respective pod cable 270a, 270b, 270c, 270d having a pod connector 271a, 271b, 271c, 271d at one end and a probe connector 272a, 272b, 272c, 272d at the other end is provided for each pod 236a, 236b, 236c, 236d to be used. The pod connector 271a, 271b, 271c, 271d of the pod cable 270a, 270b, 270c, 270d is connected to its respective pod 236a, 236b, 236c, 236d on the instrument 201, and the probe connector 272a, 272b, 272c, 272d is connectable to its mating probe 280a, 280b, 280c, 280d on the target system board 30.

In operation, when a user chooses to have the pod cables 270a, 270b, 270c, 270d extend out the front face of the logic analyzer 201 rather than the rear ash shown in FIG. 5B, the user accesses the cable tray 100, preferably by setting the logic analyzer 201 onto its side. Accordingly, the logic analyzer 201 preferably provides rubber or plastic casters 202 on at least one of the sides just for the purpose of positioning the logic analyzer 201 on its side. Once the user has access to the cable routing tray 100, for example as shown in FIG. 5C, for each connected pod 236a, 236b, 236c, 236d, the user squeezes the pod cable 270a, 270b, 270c, 270d from its normally flat (40-pin ribbon cable) layout position to a folded position to allow the cable 270a, 270b, 270c, 270d to clear the channel tabs 130a, 130b, 130c, 130d and fit into the respective channel 120a, 120b, 120c, 120d corresponding to the pod 236a, 236b, 236c, 236d. The user pushes the cable 270a, 270b, 270c, 270d into the channel 120a, 120b, 120c, 120d around each tab 130a, 130b, 130c, 130d of the channel. Once the cable is fully inserted into the channel, the user then flattens the cable to return it to its normal layout position such that the tabs 130 prevent the cable from unintentionally falling out of the channel. The user then preferably pulls the cable 270a, 270b, 270c, 270d towards the front of the logic analyzer 201 to take up any slack. The same operation is performed for each pod cable 270a, 270b, 270c, 270d corresponding to each pod 236a, 236b, 236c, 236d to be used. The logic analyzer 201 is then returned to its normal upright position, and all of the pod cables extend outward from the front panel 220 as shown in FIGS. 5D and 5E.

To switch the cables to extend out the back of the logic analyzer 201 rather than the front, the user accesses the tray 100, preferably by turning the instrument 200 on its side, and for each cable 270a, 270b, 270c, 270d routed through a channel 120a, 120b, 120c, 120d in the cable routing tray 100, squeezes the cable to a folded layout position, pulls the cable out of the channel around each tab 130a, 130b, 130c, 130d, flattens the cable to its normal flat layout position, and pulls the cable to the rear of the logic analyzer 201 to take up any slack. The user then returns the logic analyzer 201 to its normal upright position, and the pod cables 270a, 270b, 270c, 270d then extend outward from to-back) without interrupting any aspect of the testing environment. When switching cable configurations, neither the logic analyzer 201 nor the target test the rear panel 230 as shown in FIGS. 5A and 5B.

It will be appreciated that one of the many advantages offered by the invention is the ability to switch cable configurations (from back-to-front or front-assembly 290 needs to be powered off. In addition, if the cables 270a, 270b, 270c, 270d are of sufficient length, the cables 270a, 270b, 270c, 270d need not be disconnected from either the pods 236a, 236b, 236c, 236d on the instrument 200 or the probes 280a, 280b, 280c, 280d on the target system board 30.

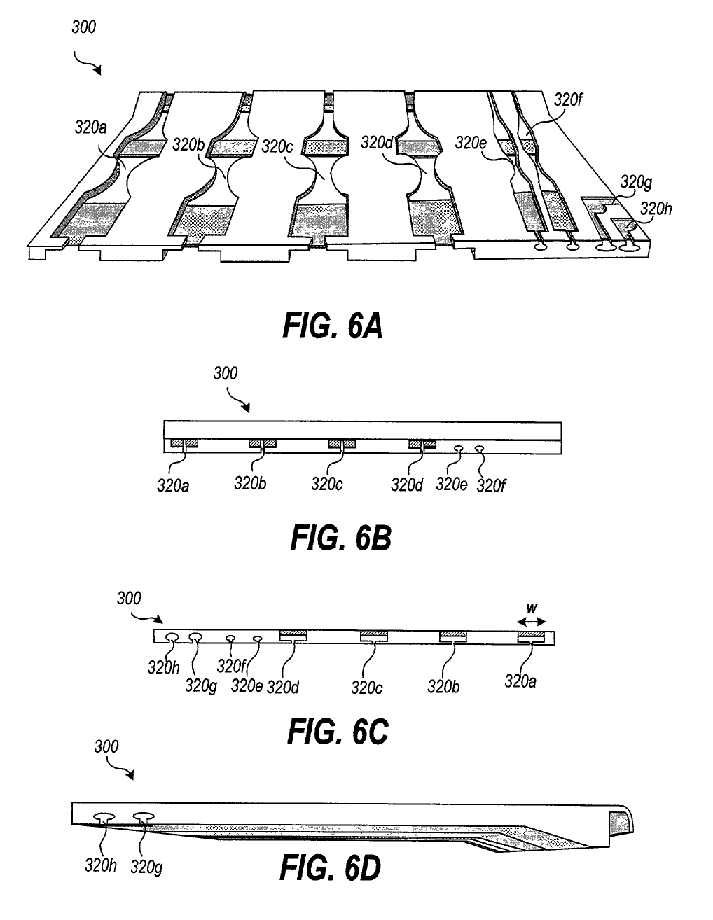

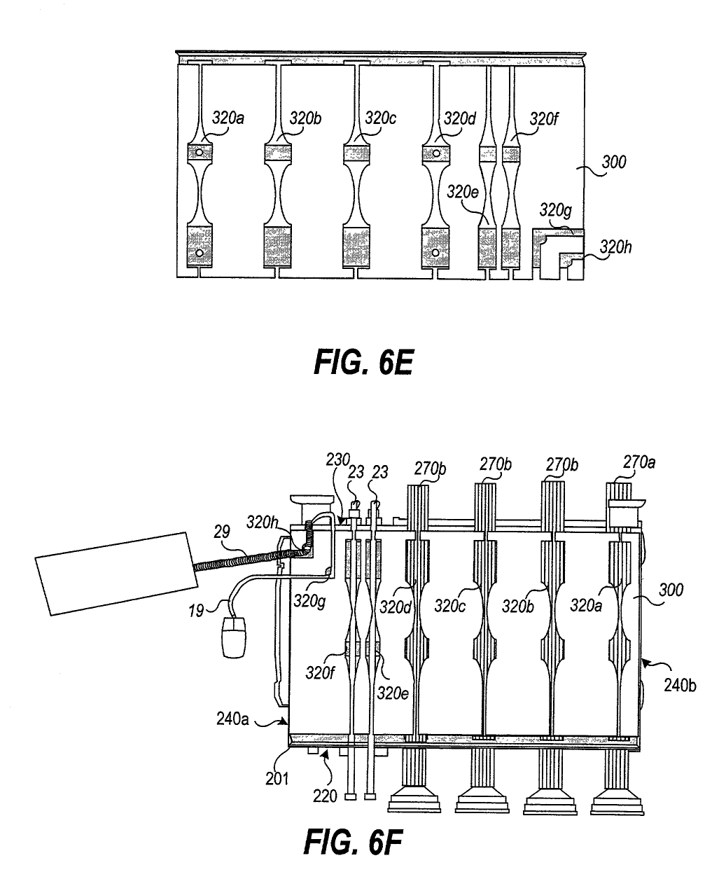

Although the illustrative embodiment of the invention provides cable routing mainly for the pod cables of the logic analyzer 201, it will be appreciated by those skilled in the art that the cable routing tray may be implemented to route cables of any type simply by forming a channel that will accommodate the cross-sectional shape of the cable of interest. FIGS. 6A-6F illustrate an example of a cable routing tray 300 for the logic analyzer 201 that will allow routing of cables connected to additional rear panel ports. In the illustrative embodiment, the routing tray 300 provides cable routing for the As illustrated, cable routing tray 300 includes cable channels 320a-320d for routing pod cables 270a-270d. In addition, cable routing tray 300 includes routing channels 320e and 320f for routing BNC coaxial cables, channel 320g for routing a mouse cable, and channel 320h for routing a keyboard cable. Of course, if desired additional channels may be formed in the routing tray to accommodate routing USB cables, parallel printer cables, serial cables, firewire cables, and LAN cables. As illustrated in FIGS. 6A-6F, pod cable channels 320a-320d and coaxial cable channels 320e and 320f for external triggering are each routed to the front of the logic analyzer 201, whereas the mouse channel 320g and keyboard channel 320h are routed to one side panel 240a of the logic analyzer 201. As also illustrated in this embodiment, the cable channels may be formed into any cross-sectional shape and follow any routing path suitable for the application. For example, in the embodiment illustrated in FIGS. 6A-6F, the pod cable channels 320a-320d and coaxial cable channels 320e are each routed in a straight path from the rear panel 230 to the front panel 220. In the same embodiment, the remaining channels 320g and 320h are routed in an L-shaped path from the rear panel 230 to one side panel 240a of the logic analyzer 201. It will be appreciated, however, that depending on the particular needs of the application, the routing path of a given channel may be configured to follow any path suitable to the application, and it is not intended that the invention be limited to channel routing paths of only straight or L-shaped paths.

It will be appreciated that the cable routing tray of the invention may be mounted on any face of the electronic instrument 200 that is suitable to the desired routing configuration respective to the positions of the various cable connectors on the instrument and the routing alternatives that are desired.

It will also be appreciated that the cable routing tray itself may formed integral to a panel itself of the electronic instrument.

The above-described invention is advantageous on several counts. On one count, the invention provides at least one additional cable routing option for cables connected on one face of an electronic instrument. On another count, the cable routing tray offers a solution to cable management, providing simple cable identification and organization. To this end, if the channels are deep enough, the length of the extended cables can be adjusted by folding the excess slack neatly into the channels, thereby also protecting the cables. Furthermore, in instruments with multiple cables routed together as a group, such as cable pairs, the cable routing tray of the invention also serves to keep the grouped cables together by routing the each group of cables through the same channel. Additionally, the cable routing solution of the invention allows the ability to switch the cable routing configuration without powering down any of the equipment or detaching any of the cables or test components.

While illustrative and presently preferred embodiments of the invention have been described in detail herein, it is to be understood that the inventive concepts may be otherwise variously embodied and employed and that the appended claims are intended to be construed to include such variations except insofar as limited by prior art.

What is claimed is:

1. A cable routing tray, comprising:
a body;
a cable routing channel formed on said body, said cable routing channel comprising an ingress for receiving a cable, an egress for outputting said cable, and a guiding path therebetween through which said cable is routed.

2. A cable routing tray in accordance with claim 1, wherein:
said cable routing channel comprises a hollow cavity formed in said body, said ingress comprising an aperture into said hollow cavity and said egress comprising an aperture out of said hollow cavity.

3. A cable routing tray in accordance with claim 2, wherein:
said body comprises an aperture into said hollow cavity in at least one position along said guiding path of said cable routing channel.

4. A cable routing tray in accordance with claim 1, wherein:
said cable routing channel comprises a groove in said body.

5. A cable routing tray in accordance with claim 4, comprising:
at least one support structure for maintaining a cable positioned in said groove.

6. A cable routing tray in accordance with claim 5, wherein:
said at least one support structure is a tab.

7. A cable routing tray in accordance with claim 1, wherein:
said ingress is located in proximity to a first edge of said body; and said egress is located in proximity to a different edge of said body.

8. An electronic instrument comprising:
a housing;
an electrical connector positioned on a first face of said housing;
a first cable routing channel formed on a second face of said computer housing, said second face adjacent to said first face of said housing, said cable routing channel comprising:
an ingress in proximity to said electrical connector for receiving a cable,
an egress in proximity to a third face of said housing for outputting said cable, and
a guiding path connecting said ingress and said egress.

9. An electronic instrument in accordance with claim 8, comprising:
a cable connected to said electrical connector, said cable positionable to extend outwards from said first face of said housing or to be routed to said third face of said housing through said first cable routing channel.

10. An electronic instrument in accordance with claim 8, comprising:
a cable routing tray mounted on said second face of said housing, said cable routing tray comprising said first cable routing channel.

11. An electronic instrument in accordance with claim 8, wherein:
said first cable routing channel comprises a hollow cavity formed inside said body, said ingress comprising an aperture into said hollow cavity and said egress comprising an aperture out of said hollow cavity.

12. An electronic instrument in accordance with claim 8, wherein:
said body comprises an aperture into said hollow cavity in at least one position along said guiding path of said first cable routing channel.

13. An electronic instrument in accordance with claim 8, wherein:
said cable routing channel comprises a groove in said body.

14. An electronic instrument in accordance with claim 13, comprising:
at least one support structure for maintaining a cable positioned in said groove.

15. An electronic instrument in accordance with claim 13, wherein:
said at least one support structure is a tab.

16. An electronic instrument in accordance with claim 8, wherein:
said ingress is located in proximity to a first edge of said body; and said egress is located in proximity to a different edge of said body.

17. An electronic instrument in accordance with claim 8, comprising;
at least one additional cable routing channel formed on said second face of computer housing, each of said at least one additional cable routing channel comprising:
a respective ingress in proximity to at least one additional respective electrical connector on said first face of said housing,
a respective egress in proximity to said third face or a fourth face of said housing for outputting said cable, and
a respective guiding path connecting said respective ingress and said respective egress.

18. An electronic instrument in accordance with claim 8, wherein:
said first cable routing channel comprises a second egress in proximity to a fourth face of said housing.

19. A method for routing a cable attached to an electronic connector mounted on a first face of an electronic instrument to a second face of said electronic instrument, comprising:
providing on said instrument a routing channel from said first face of said electronic instrument to said second face of said electronic instrument, said routing channel comprising an ingress in proximity to said electrical connector for receiving said cable, an egress in proximity to a third face of said housing for outputting said cable, and a guiding path therebetween.

20. A method in accordance with claim 19, comprising:
inserting said cable into said routing channel such that said cable enters said routing channel at said ingress and exits said channel at said egress.
